(19) United States
(12) Patent Application Publication
(10) Pub. No.: US 2024/0256711 A1
(43) Pub. Date: Aug. 1, 2024

(54) User Scene With Privacy Preserving Component Replacements

(71) Applicant: Meta Platforms Technologies, LLC, Menlo Park, CA (US)

(72) Inventors: Yuichi TAGUCHI, Los Gatos, CA (US); Gioacchino NORIS, Zurich (CH); Jessica ABAD KELLY, London (GB); Andrea SCHAAF, Kirkland, WA (US); David SERRANO, London (GB); Cosmin CONSTANTIN, London (GB)

(73) Assignee: Meta Platforms Technologies, LLC, Menlo Park, CA (US)

(21) Appl. No.: 18/587,597

(22) Filed: Feb. 26, 2024

Related U.S. Application Data
(60) Provisional application No. 63/496,544, filed on Apr. 17, 2023.
(60) Provisional application No. 63/495,847, filed on Apr. 13, 2023.

(51) Int. Cl. G06F 21/62; G06T 13/40; G06T 19/00

(52) U.S. Cl. CPC G06F 21/6254; G06T 13/40; G06T 19/006

(57) ABSTRACT

In some implementations, the disclosed systems and methods can replace components descriptive of private real-world objects with generic components that obscure details of the private real-world objects, such as the objects' structure and semantic information. In some implementations, the disclosed systems and methods can convert image and/or sensor data into pose data that can be used by a recipient device to animate an avatar of the sender while the audio stream is being played.

### CROSS REFERENCE TO RELATED APPLICATIONS

This application claims priority to U.S. Provisional Application No. 63/496,544, titled “User Scene with Privacy Preserving Component Replacements,” filed on Apr. 17, 2023 and to U.S. Provisional Application No. 63/495,847, titled “Avatar Messages,” filed on Apr. 13, 2023, each of which is herein incorporated by reference in their entireties.

### BACKGROUND

Artificial reality systems have grown in popularity with users, and this growth is expected to accelerate. Some artificial reality, such as mixed reality or augmented reality, includes pass-through visualizations of real-world environment(s) with artificial reality augmentations, such as virtual objects, animations, filters, and other suitable augmentations. Artificial reality augmentations in pass-through visualizations of a real-world environment often rely on a mapping of the real-world environment for positioning and display of the augmentations. Such a mapping can also be used to generate a virtual reality environment that corresponds to a mapped real-world environment.

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a waveguide that simultaneously emits light from a projector in the MR HMD, allowing the MR HMD to present virtual objects intermixed with real objects the user can actually see.

### SUMMARY

Aspects of the present disclosure are directed to providing a user scene with privacy preserving components. A user scene can be a scene graph of a space (e.g., room, skybox, etc.) and components within the space. For example, the scene can represent a user's real-world room and the components can represent real-world objects. However, when exposing the user scene to third-party applications in an unfiltered form, the scene may provide too detailed a representation of the real-world room. A scene privacy manager can replace components descriptive of private real-world objects with generic components that obscure details of the private real-world objects, such as the objects' structure and semantic information. A generic component can take a geometric shape that is based on the size of the private real-world object it obscures. Accordingly, the applications are provided sufficient information about the user's real-world room, however details about private real-world objects are obscured.

Additional aspects of the present disclosure are directed to avatar messages in a message exchange. An artificial reality (XR) device can capture audio, image, and/or sensor data while a user is speaking a message. Instead of sending the raw audio, image, and/or sensor data as a video message or animated avatar message, however, some implementations can convert the image and/or sensor data into pose data that can be used by a recipient device to animate an avatar of the sender while the audio stream is being played. By only sending audio and pose data, some implementations allow for fast and low bandwidth animated messages, while still feeling connected through avatar interactions.

### BRIEF DESCRIPTION OF THE DRAWINGS

FIG. 1 is a conceptual diagram of a user scene comprising scene components.

FIG. 2 is a conceptual diagram of a user scene with privacy preserving generic scene component replacements.

FIG. 3 is a flow diagram illustrating a process used in some implementations for providing a user scene with privacy preserving components.

FIG. 4A is a conceptual diagram of an example user interface for exchanging messages on an artificial reality device.

FIG. 4B is a conceptual diagram of an example user interface having an option to send an avatar message in a messaging conversation on an artificial reality device.

FIG. 4C is a conceptual diagram of an example user interface to record an avatar message on an artificial reality device.

FIG. 4D is a conceptual diagram of an example user interface to delete, review, or send a recorded avatar message on an artificial reality device.

FIG. 4E is a conceptual diagram of an example user interface for exchanging messages, including an avatar message, on an artificial reality device.

FIG. 4F is a conceptual diagram of an example user interface for displaying a received avatar message, on an artificial reality device.

FIG. 5 is a conceptual diagram illustrating an example kinematic model of a user.

FIG. 6 is a flow diagram illustrating a process used in some implementations for providing an avatar message by an artificial reality device.

FIG. 7 is a block diagram illustrating an overview of devices on which some implementations of the present technology can operate.

FIG. 8 is a block diagram illustrating an overview of an environment in which some implementations of the present technology can operate.

### DESCRIPTION

Aspects of the present disclosure are directed to providing a user scene with privacy preserving components. A user scene can be a scene graph of a space (e.g., room, skybox, etc.) and components within the space. For example, the user scene can represent a user's real-world room and the components can represent real-world objects in the user's real-world room. However, when exposing the user scene to third parties, such as artificial reality (XR) applications, in an unfiltered form, the user scene may provide too detailed a representation of the user's real-world room. A scene privacy manager can replace components descriptive of private real-world objects with generic components that obscure details of the private real-world objects, such as the objects' structure and semantic information. In some implementations, the generic components comprise a geometric shape (e.g., box, ellipsoid, etc.) that is based on the size and shape of the private real-world object it obscures. Accordingly, the XR application is provided sufficient information about the user's real-world room and real-world objects in the room for application functionality, however details about private real-world objects are obscured to maintain user privacy.

In some implementations, a user scene can be a captured and mapped user real-world environment. For example, the user's real-world environment can include a space (e.g., room, building, outdoor space, etc.) and a number of real-world objects. Input from one or more sensing devices, such as cameras, depth sensors, IMU sensors, GPS units, LiDAR or other time-of-flights sensors, etc., can be used to identify and map the physical environment. This simultaneous localization and mapping (SLAM) system can generate maps (e.g., topologies, girds, etc.) for the space and/or obtain maps previously generated. In some implementations, a SLAM system can track the user within the area based on factors such as matched spatial anchors (based on computer vision), GPS data, matching identified objects and structures to mapped objects and structures, monitoring acceleration and other position changes, etc.

In some implementations a user guided workflow can assist in mapping a room and the real-world objects contained in the room. For example, a workflow can direct a user donning a head-mounted display and carrying one or more hand-held controllers to: capture, using cameras of the head-mounted displays, images of the room/objects; physically move to different locations of the room; and/or move the one or more hand-held controllers to scan portions of the room/objects. The signals captured via the user guided workflow can be used to generate a three-dimensional mapping of the room and the real-world objects.

A user scene can be generated using the captured and mapped real-world environment. The user scene can include a three-dimensional space (e.g., the room, a skybox, etc.) and three-dimensional components within the three-dimensional space. For example, a user scene of a mapped room can be the three-dimensional space that corresponds to the 6 boundaries of the room (e.g., left wall, right wall, forward wall, back wall, ceiling, and floor), and three-dimensional components that correspond to the real-world objects in the room. Each scene component can comprise a three-dimensional structure (e.g., mesh structure) based on its corresponding real-world object and a relative location within the three-dimensional space. In some implementations, the user scene comprises a scene graph of the three-dimensional space and the scene components.

In some implementations, the scene components can include semantic information about their corresponding real-world objects. For example, semantic information about the real-world objects can be received from the user and/or determined by one or more machine learning models. In some implementations, during a user guided workflow, a user can provide data descriptive of the real-world objects in a room, and this descriptive data can be used to generate semantic information for the scene components that correspond to the real-world objects. Example semantic information includes an object type (e.g., painting, couch, chair, table, bed, etc.), an object use (e.g., seating area, etc.), and other suitable object information. In some implementations, one or more machine learning models can process sensor data (e.g., images) of real-world objects to determine semantic information about the real-world objects. For example, computer vision model(s) can perform object detection (e.g., detecting objects in an image or video) and object recognition (e.g., recognizing or classifying the detected object) on the real-world objects to derive the semantic information.

Implementations can compare the scene components of a user scene with privacy criteria defined for/by a user and, based on the comparison, replace one or more scene components with generic scene components. For example, the generic scene components can comprise a generic shape (e.g., box, ellipsoid, etc.) and may comprise no or generic semantic information. The replacement of a given scene component that corresponds to a given real-world object with a generic scene component can maintain user privacy with respect to the given real-world object. Accordingly, when the user scene is shared, for example with a XR application, the geometry of the user's real-world environment is partially obscured from the XR application. For example, the XR application can receive a user scene with a generic component that comprises generic or no semantic information instead of a scene component that comprises the three-dimensional shape (e.g., mesh structure) and semantic information of the given real-world object.

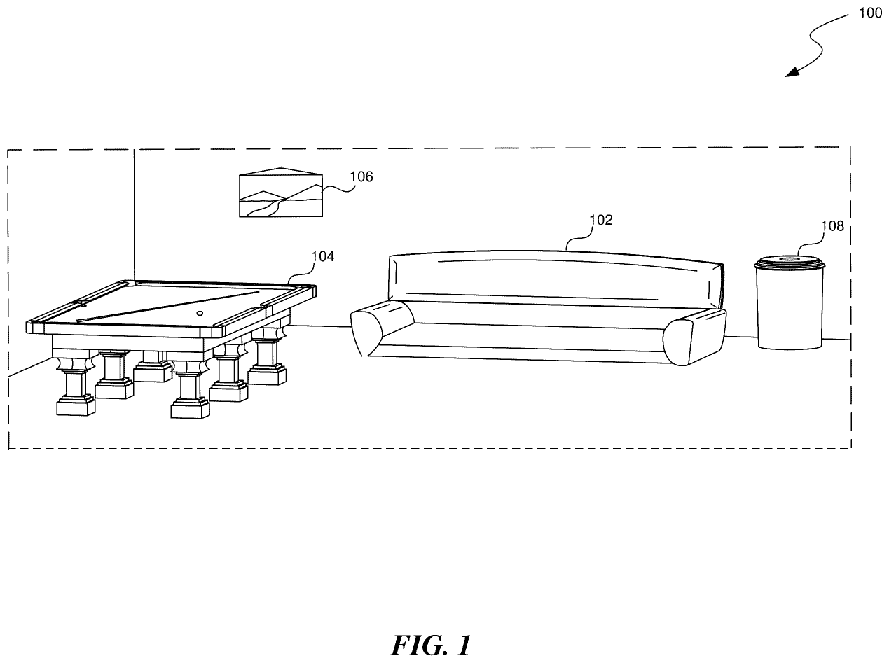

FIG. 1 is a conceptual diagram of a user scene comprising scene components. User scene 100 comprises scene components 102, 104, 106, and 108. The user's real world environment, mapped as user scene 100, can include a number of real-world objects, mapped as scene components 102, 104, 106, and 108. For example, scene component 102 can correspond to a real-world couch object, scene component 104 can correspond to a real-world pool table object, scene component 106 can correspond to a real-world hanging painting object, and scene component 108 can correspond to a real-world waste basket object.

Implementations can compare the scene components 102, 104, 106, and 108 to a privacy criteria to identify one or more components that match the criteria. For example, scene components 102, 104, 106, and 108 can comprise semantic information descriptive of the real-world objects that correspond to these components. Example semantic information for scene component 102 can be ‘furniture’, ‘couch’, ‘seating area’, or other suitable semantic information. Example semantic information for scene component 104 can be ‘furniture’, ‘pool table, ‘entertainment object’, ‘non-seating area’, or other suitable semantic information. Example semantic information for scene component 106 can be ‘wall object’, ‘painting’, ‘decor object’, or other suitable semantic information. Example semantic information for scene component 106 can be ‘miscellaneous object’, ‘waste basket’, or other suitable semantic information.

In some implementations, a scene privacy manager can detect private components among scene components 102, 104, 106, and 108. For example, the scene privacy manager can compare each scene component's semantic information to a privacy criteria to detect private components. Example privacy criteria include allowlist criteria, blocklist criteria, and the like. When implementing an allowlist criteria, the scene privacy manager can, by default, detect components as private components unless the allowlist criteria applies to the components' semantic information. For example, allowlist criteria of ‘seating area’ can apply to scene component 102, but not to scene components 104, 106, and 108. In this example, scene components 104, 106, and 108 can be detected as private components.

When implementing a blocklist criteria, the scene privacy manager, can, by default, detect components as non-private components unless the blocklist criteria applies to the components' semantic information. For example, the blocklist criteria of “decor object’, ‘entertainment object’, and ‘miscellaneous object’ can apply to scene components 104, 106, and 108, but not to scene component 102. In this example, scene components 104, 106, and 108 can be detected as private components. Any other suitable privacy criteria can be applied by scene privacy manager.

In some implementations, scene privacy manager can detect private objects based on user preferences. For example, the user can identify individual real-world objects as private and non-private, and/or define semantic information that indicates private or non-private objects. In some implementations, object detection by one or more machine learning models can detect private objects, such as objects that include alphanumeric symbols, objects identified as photographs, and the like. The scene privacy manager can then replace private components of a user scene with generic components.

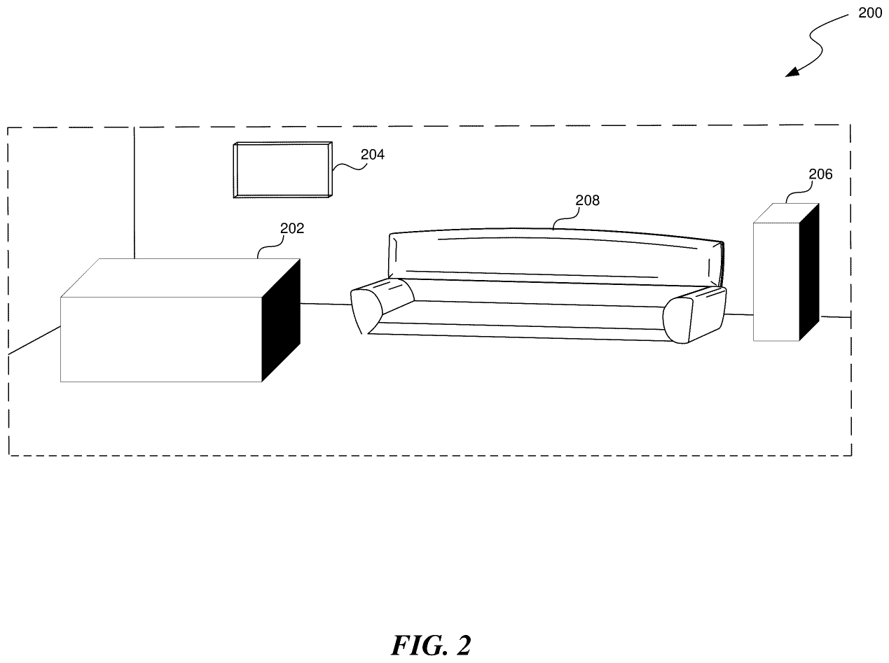

FIG. 2 is a conceptual diagram of a user scene with privacy preserving generic scene component replacements. Privacy preserving user scene 200 comprises scene component 210 and generic scene components 202, 204, and 206. Referring back to FIG. 1, the scene privacy manager can detect scene components 104, 106, and 108 as private components. The scene privacy manager can replace scene components 104, 106, and 108 with generic components 202, 204, and 206, respectively. The semantic information for generic components 202, 204, and 206 can be ‘none’, ‘neutral’, or ‘unavailable’. In addition, generic components 202, 204, and 206 comprise a geometric shape (e.g., box, ellipsoid, etc.) that corresponds to the size of scene components 104, 106, and 108, respectively, but hides the geometry (e.g., mesh structure) of the real-world objects that correspond to these components. Scene component 210 can correspond to a scene component that is not detected as a private scene component, and thus the full scene component (e.g., mesh structure, semantic information, etc.) can be included in privacy preserving user scene 200. Accordingly, generic components 202, 204, and 206 preserve user privacy while exposing privacy preserving user scene 200 to third-party XR applications.

In some implementations, a generic component can comprise a shape that corresponds to the general shape of the real-world object it obscures, however this general shape still hides the geometry of the real-world object. For example, generic scene component 202 obscures a real-world pool table (as illustrated in FIG. 1). Generic component 202 can comprise several different geometric shapes (e.g., boxes) that resemble the size and shape of the real-world pool table without the additional descriptive visual detail that identify the component as a pool table (e.g., pool table pockets, surface designs, pool balls, etc.).

In some implementations, privacy preserving user scene 200 is shared with XR applications to communicate the ‘free space’ available in a use's real-world room. For example, scene component 210 and generic scene components 202, 204, and 206 can identify, for XR applications, the portions of a user's real-world room that are occupied by objects, and thus are not ‘free space’. These XR applications can then utilize the available ‘free space’ in a user's room for application functionality (e.g., virtual object display, etc.). XR applications can utilize privacy preserving user scene 200 in any other suitable manner.

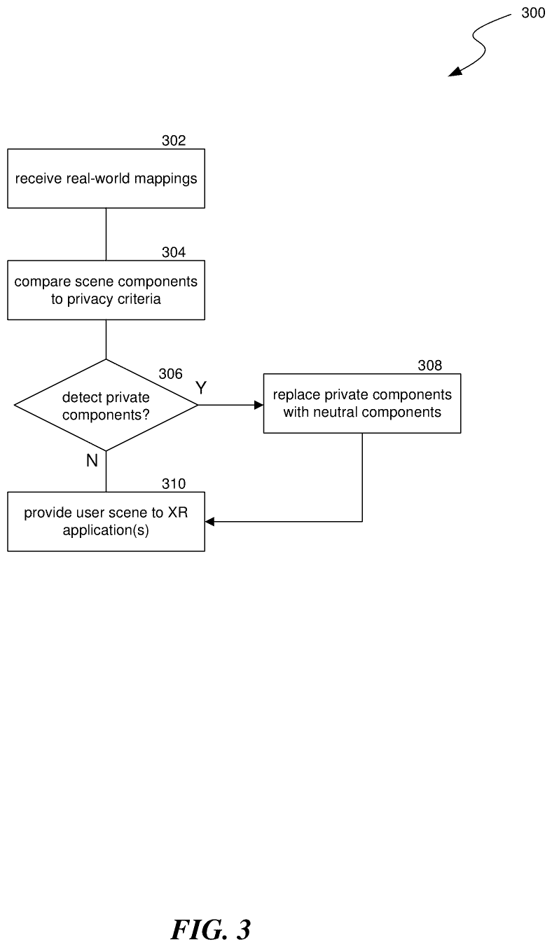

FIG. 3 is a flow diagram illustrating a process used in some implementations for providing a user scene with privacy preserving components. In some implementations, process 300 can triggered in response to receiving a user scene. In some implementations, process 300 can be performed at a XR system and/or remote system (e.g., cloud or edge system).

At block 302, process 300 can receive a user scene with real-world mappings of a real-world space and real-world objects. For example, a user scene can be generated based on a user's captured and mapped real-world environment. The user scene can include a three-dimensional space and three-dimensional components within the three-dimensional space, such as a room and objects within the room. For example, a user scene of a mapped room can be the three-dimensional space that corresponds to the 6 boundaries of the room (e.g., left wall, right wall, forward wall, back wall, ceiling, and floor), and three-dimensional components that correspond to the real-world objects in the room. Each scene component can comprise a three-dimensional structure (e.g., mesh structure) based on its corresponding real-world object and a relative location within the three-dimensional space.

In some implementations, the scene components can comprise semantic information. For example, semantic information about the real-world objects that correspond to the scene components can be received from the user and/or determined by one or more machine learning models. Example semantic information includes an object type (e.g., painting, couch, chair, table, bed, etc.), an object use (e.g., seating area, etc.), and other suitable object information.

At block 304, process 300 can compare scene components to a privacy criteria. For example, each scene component's semantic information can be compared to a privacy criteria. Example privacy criteria include allowlist criteria, blocklist criteria, and the like. When implementing an allowlist criteria, components can be identified as private components by default unless the allowlist criteria applies to the components' semantic information. When implementing a blocklist criteria, components can be identified as non-private components by default unless the blocklist criteria applies to the components' semantic information. Implementations can apply any other suitable privacy criteria.

At block 306, process 300 can determine whether any private objects are detected in the user scene. For example, after comparing the components' semantic information to a privacy criteria, one or more private components can be detected. In some implementations, private components can be detected based on user preferences. For example, the user can label individual real-world objects as private and non-private, and/or define semantic information that indicates private or non-private objects. These labels and/or indications can control private or non-private status of the scene components that correspond to the real-world objects. In some implementations, object detection by one or more machine learning models can detect private real-world objects, such as objects that include alphanumeric symbols, objects identified as photographs, and the like. When private component(s) are detected, process 300 can progress to block 308. When private objects are not detected, process 300 can progress to block 310.

At block 308, process 300 can replace the detected private components(s) with generic components. For example, a given private component can correspond to a give real-world object located in the real-world space mapped for the user scene. The given private component can be replaced with a generic component that comprises a general shape based on the given real-world object. For example, the shape of the generic component can be a geometric shape, or multiple geometric shapes oriented based on the structure of the given real-world object. In addition, the semantic information for the generic component can be ‘none’, ‘neutral’, ‘not available’, and the like. Each private component detected in the user scene can be replaced with a generic component.

At block 310, process 300 can provide the user scene to one or more XR applications. For example, the provided user scene can include one or more scene components and one or more generic components. Each scene component can comprise: a shape (e.g., mesh structure) that corresponds to the geometry of the real-world object to which the scene component corresponds; and semantic information descriptive of this real-world object. Each generic component can comprise: a shape that comprises a geometric shape or multiple geometric shapes in a suitable orientation; and no semantic information or neutral semantic information.

The generic components can obscure one or more real-world objects in the user's mapped space that are private. In some implementations, each generic component comprises approximate dimensions that match each obscured private real-world object. The XR application can use the provided user scene to determine the ‘free space’ in the user's mapped space, such as the space that is not occupied by real-world objects. The XR application can then utilize this free space, such as by display virtual objects in a XR environment at locations that corresponds to this free space.

Aspects of the present disclosure are directed to avatar messaging in a multi-user message exchange, chat, or conversation on an artificial reality (XR) device. The XR device can receive multimodal input from the user, including an audio stream of the user speaking, as well as tracking input indicative of motion by the user while speaking. The tracking input can include, for example, image input (e.g., picture(s) and/or video(s)), sensor input (e.g., as collected by one or more sensors of an inertial measurement unit (IMU), one or more electromyography (EMG) sensors, etc.), which can be collected by the XR device (e.g., via one or more cameras), or by another device in operable communication with the XR device, such as a wearable device. The XR device can translate the tracking input into pose data by mapping the image stream to a kinematic model, e.g., a skeletal model, which can correspond in time to the audio stream, such that certain pose data points are correlated to certain words being spoken. The XR device can transmit the audio stream and the pose data, such as to a remote server, which can relay the data to a recipient device for the message (which, in some implementations, can also be an XR device). The recipient device can receive the audio stream and the pose data, define motions for an avatar of the sending user by applying inverse kinematics to the pose data and mapping it to the avatar, and display the avatar message by playing the audio stream in correspondence to the motions of the avatar.

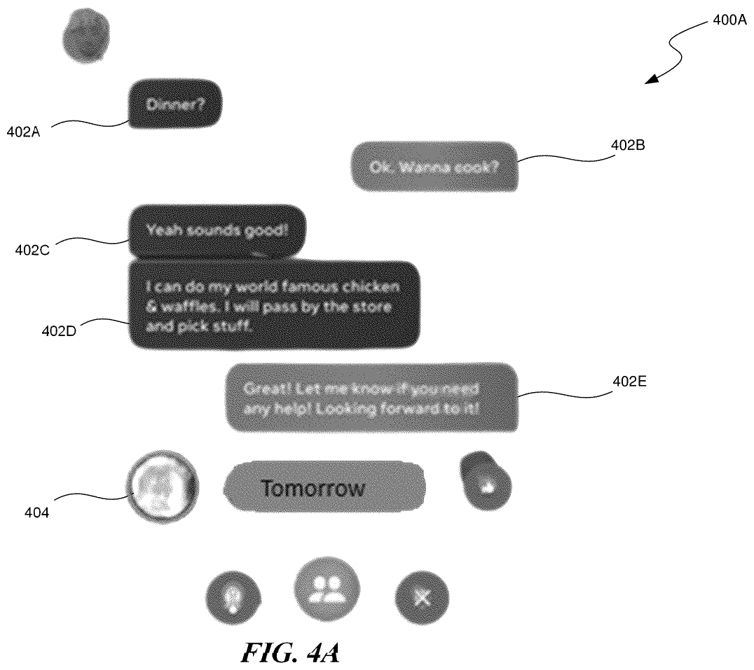

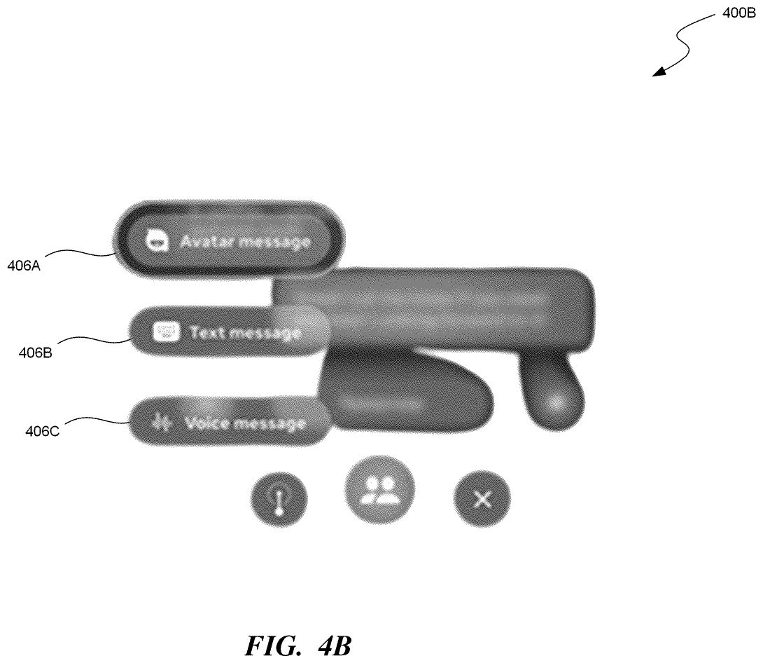

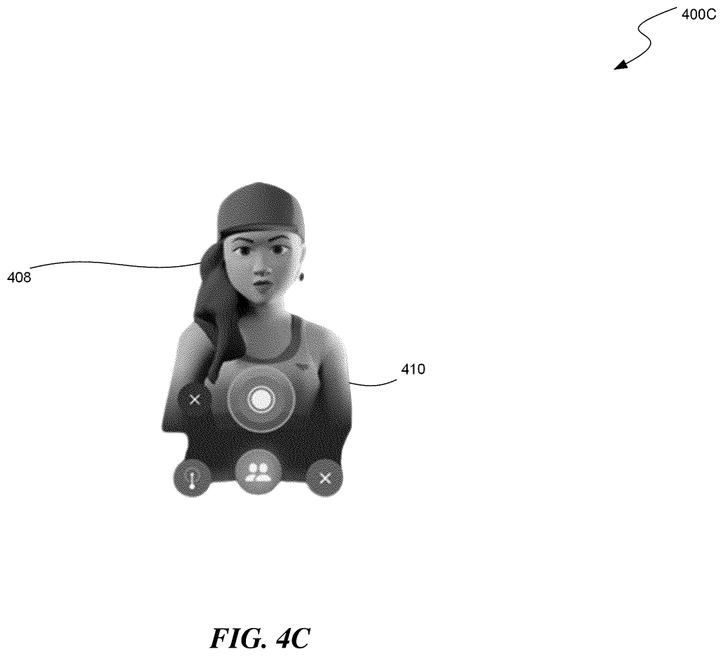

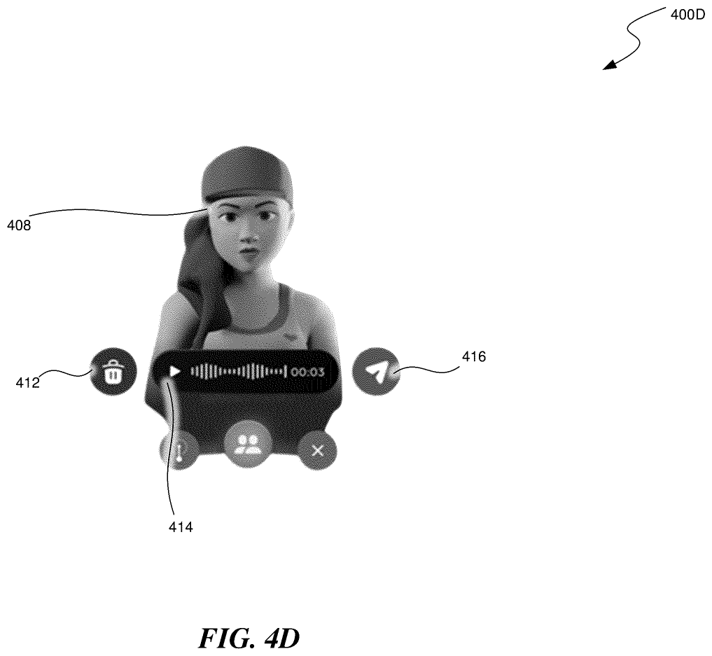

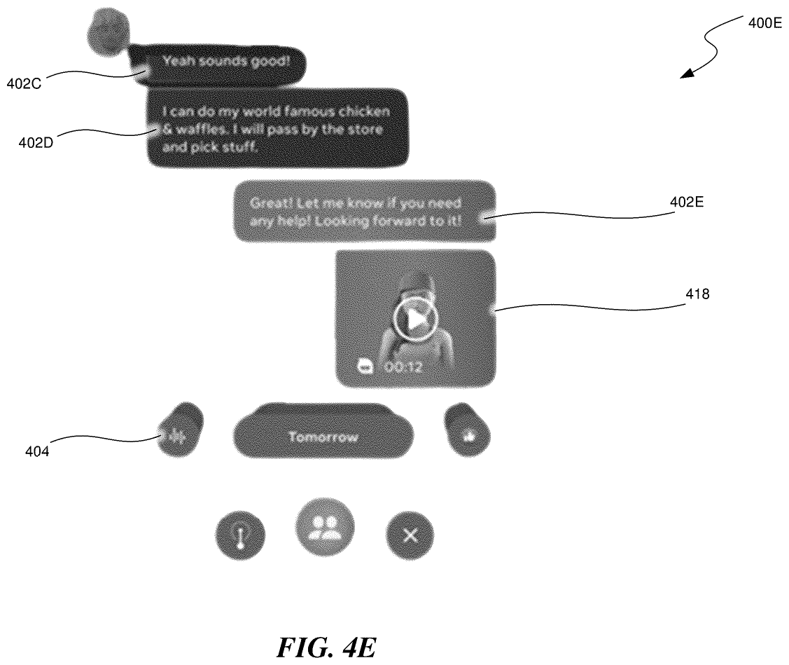

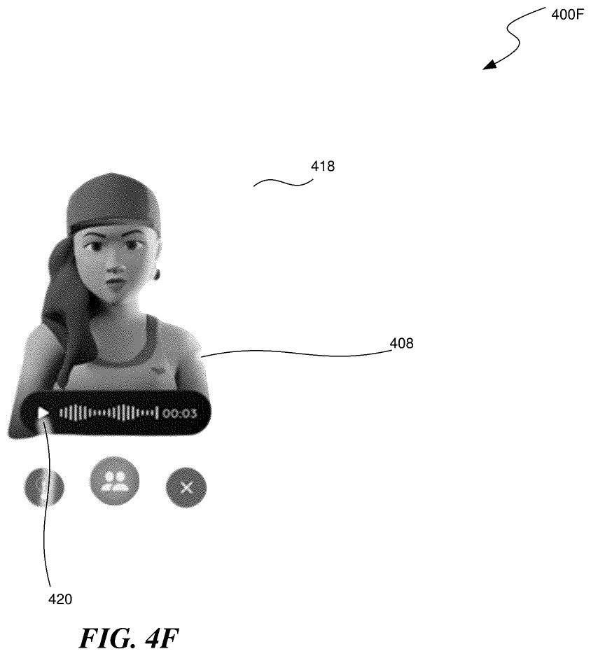

FIG. 4A is a conceptual diagram of an example user interface 400A for exchanging messages on an artificial reality (XR) device. The XR device can display user interface 400B as a response to a user (e.g., a sending user) opening a messenger application or experience, and/or by the user initiating a message exchange with a receiving user. In some implementations, the receiving user can also be using an XR device to access the messenger application, while in other implementations, the receiving user can be using a two-dimensional (2D) interface to access the messenger application, such as a mobile device, a computing device, etc. While engaging in the message exchange, the receiving user (via a recipient device) can transmit messages 402A, 402C, and 402D, while the sending user (via the XR device) can send messages 402B, 402E. The sending user can choose to send a media message, which can be accessed by selecting media button 404, via a gesture, hand controller, or audible announcement, for example.

FIG. 4B is a conceptual diagram of an example user interface 400B having an option 406A to send an avatar message in a messaging conversation, including messages 402A-E, on an artificial reality (XR) device. From user interface 400A of FIG. 4A, the sending user can select media button 404 to display options 406A-C. Option 406A can be an option to generate avatar message 418, option 406B can be an option to generate a text message, and option 406C can be an option to generate a voice message. Thus, to generate an avatar message, the sending user can select option 406A from the list via a gesture, hand controller, or audible announcement, for example.

FIG. 4C is a conceptual diagram of an example user interface 4000 to record an avatar message on an artificial reality (XR) device. From user interface 400B of FIG. 4B, the sending user can select option 406A to generate avatar message 418, thereby displaying user interface 4000. Thus, the chat layout can disappear and be replaced by user interface 4000. User interface 4000 can display an avatar 408 of the sending user. Avatar 408 could have been previously configured by the user to reflect her look and style, for example, and can be either two-dimensional (2D) or three-dimensional (3D). From user interface 4000, the sending user can select record button 410 to begin recording an audio stream of a spoken message. While the audio stream is recorded, in some implementations, the XR device can capture movements of the sending user and correlate such movements to movements of avatar 408. For example, the XR device can capture an image stream showing the user moving while she's speaking (e.g., movements of her mouth, face, eyes, expressions, arms, etc.). The XR device can correlate such movements into pose data by mapping the movements to a kinematic model, i.e., a skeletal model of the user. The pose data can be projected onto a kinematic model of avatar 408 to cause avatar 408 to move correspondingly to the audio stream while being recorded. In other words, avatar 408 can act as a “mirror” for the user, moving her arms, mouth, and head based on the audio and movement input. To stop the recording, the sending user can again select recording button 410, which can be replaced with a “stop” icon (not shown) once recording is initiated in some implementations.

FIG. 4D is a conceptual diagram of an example user interface 400D to delete, review, or send a recorded avatar message 418 on an artificial reality (XR) device. From user interface 4000, the sending user can select recording button 410, while recording, to end the recording of the avatar message. Upon selection of recording button 410 to end the recording, the XR device can display user interface 400D. User interface 400D can allow the sending user to preview avatar message 418, e.g., by selecting preview button 414. Upon selection of preview button 414, the XR device can play back the recorded audio stream, and/or animate avatar 408 as was recorded. From user interface 400D, the sending user can further erase the avatar message (via erase button 412), or send the avatar message via send button 416.

FIG. 4E is a conceptual diagram of an example user interface 400E for exchanging messages, including an avatar message 418, on an artificial reality (XR) device. From user interface 400D of FIG. 4D, the sending user can select send button 416, which can take her back to the chat thread. From the chat thread, the sending user can see messages 402C-E, and avatar message 418, which can be transmitted to the receiving user via the recipient device. Avatar message 418 can be transmitted to the recipient device as pose data and audio data, instead of transmitting a video feed of the movements of the avatar. The receiving user can select avatar message 418 to expand and view it.

FIG. 4F is a conceptual diagram of an example user interface 400F for displaying a received avatar message 418 on an artificial reality (XR) device, which can be the recipient device in this example. The receiving user can select to play avatar message 418 from the chat thread, thereby rendering user interface 400F on the recipient device. The receiving user can select play button 420 to play avatar message 418. The recipient device can map the received pose data to a kinematic model of avatar 408 in order to animate avatar 408 according to the sending user's captured motions, while the audio stream is being played, corresponding in time to the motions.

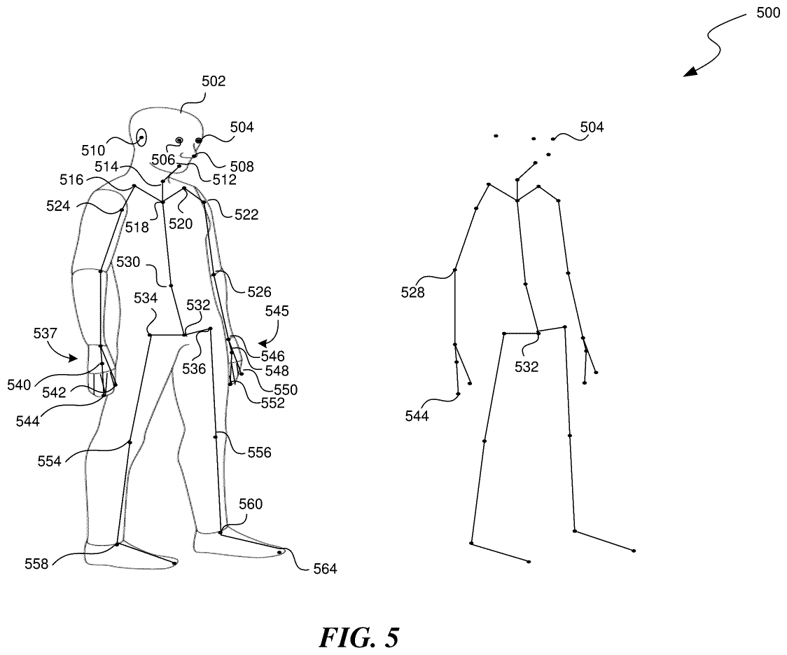

FIG. 5 is a conceptual diagram illustrating an example 500 kinematic model of a user. On the left side, example 500 illustrates points defined on a body of a user 502 while these points are again shown on the right side of FIG. 5 without the corresponding person to illustrate the actual components of the kinematic model. These points include eyes 504 and 506, nose 508, ears 510 (second ear point not shown), chin 512, neck 514, clavicles 516 and 520, sternum 518, shoulders 522 and 524, elbows 526 and 528, stomach 530, pelvis 532, hips 534 and 536, hands 537 and 545, wrists 538 and 546, palms 540 and 548, thumb tips 542 and 550, finger tips 544 and 552, knees 554 and 556, ankles 558 and 560, and tips of feet 562 and 564. In various implementations, more or less points are used in the kinematic model. Some corresponding labels have been put on the points on the right side of FIG. 5, but some have been omitted to maintain clarity. Points connected by lines show that the kinematic model maintains measurements of distances and angles between certain points. Because points 504-510 are generally fixed relative to point 512, they do not need additional connections.

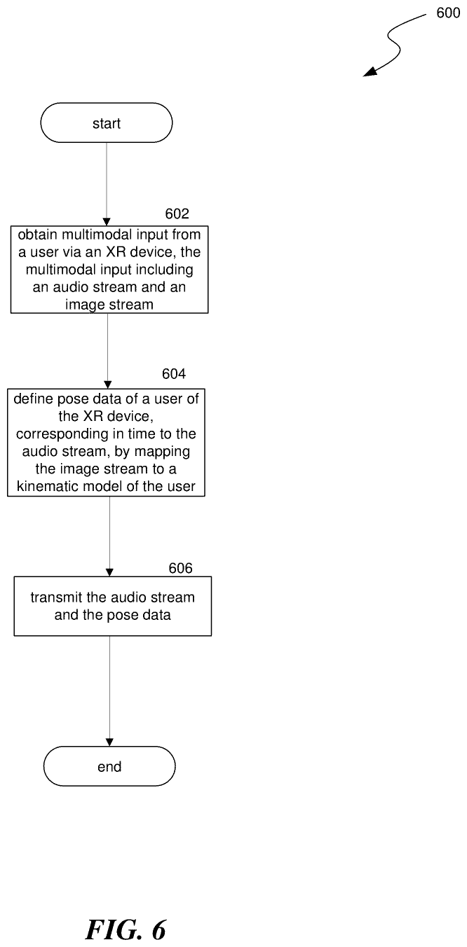

FIG. 6 is a flow diagram illustrating a process 600 used in some implementations for providing an avatar message by an artificial reality (XR) device. In some implementations, process 600 can be performed as a response to a user request to generate an avatar message in a multi-user message exchange, chat, or conversation. In some implementations, some or all of process 600 can be performed by an XR head-mounted display (HMD). In some implementations, some or all of process 600 can be performed by another XR device in an XR system, such as processing components separate from an XR HMD. In some implementations, process 600 can be performed by a mixed reality (MR) HMD, such as MR glasses. Although described primarily herein as being performed on an XR device, however, it is contemplated that process 600 can alternatively be performed on a two-dimensional (2D) interface, such as a mobile device.

At block 602, process 600 can obtain multimodal input from a sending user via an XR device. The multimodal input can include an audio stream of the sending user speaking a message to a recipient user. Process 600 can obtain the audio stream, for example, via one or more microphones integral with or in operable communication with the XR device. In some implementations, the multimodal input can further include tracking data. The tracking data can include, for example, data indicative of movements by the user while speaking the audio stream. In some implementations, the tracking data can include image(s) (which can include an image stream, i.e., video). The image(s) can be captured by one or more cameras integral with or in operable communication with the XR device. In some implementations, the one or more cameras can include cameras pointed away from the user, e.g., can capture movements of the user's body without the face. In some implementations, however, the one or more cameras can include at least one camera pointed toward the user, e.g., can capture movements of the user's eyes, mouth, facial expressions, etc.

In some implementations, the tracking data can include sensor data, e.g., as captured by an inertial measurement unit (IMU) integral with or in operable communication with the XR device. In some implementations, the tracking data can include electromyography (EMG) data, e.g., as captured by one or more EMG sensors integral with or in operable communication with the XR device. In some implementations, the IMU and/or EMG sensors can be included on a wearable device, such as a smart wristband, thereby capturing waveforms indicative of motion of the hands, fingers, arms, etc., which, in some implementations, can be correlated to gestures. In some implementations, the IMU and/or EMG sensors can be included in one or more hand controllers in operable communication with the XR device. A non-exhaustive list of elements that can define the pose of the sending user while recording the audio stream can include a positioning of one or more of the user's head, an eye or eyes of the user, a face of the user, a hand or hands of the user, an arm or arms of the user, and/or a leg or legs of the user. In some implementations, the tracking data can correspond in time to the audio stream, such that movements by the user are correlated to particular points in time of the speech input, such as when certain words are spoken.

At block 604, process 600 can define pose data of the user, corresponding in time to the audio stream, by mapping the tracking data to a kinematic model of the user. The kinematic model can define, according to anatomical capabilities and constraints, a body configuration of the user that can yield one or more postures of the user. By mapping the tracking data to the kinematic model, process 600 can define poses of the user according to relative positioning for the user's head, hands, arms, legs, etc. In some implementations, process 600 can further define pose data of the user, particularly with respect to movement of the user's mouth while speaking, using artificial intelligence (AI) techniques to predict how the user's mouth would move to speak particular words, e.g., based on the words spoken, based on emphasis on particular words or syllables, based on tone of voice, etc.

At block 606, process 600 can transmit the audio stream and the pose data. Process 600 can transmit the audio stream and the pose data over any suitable network described herein. In some implementations, process 600 can transmit the audio stream and the pose data to a recipient device, associated with a receiving user, via a remote server, such as a platform computing system associated with the system of the XR device, or a developer computing system associated with the messaging application installed on the XR device. In some implementations, the recipient device can also be an XR device. In some implementations, however, the recipient device need not be an XR device, and can instead be a 2D interface, such as a mobile device, a computer, tablet, etc.

The recipient device can receive the audio stream and the pose data. The recipient device can further define a plurality of motions for an avatar of the sending user by mapping the pose data to a kinematic model of the avatar. The kinematic model of the avatar can define a virtual anatomical body composition of the avatar. For example, the recipient device can map points and motions in the pose data, corresponding to the kinematic model of the user, to corresponding points and motions in the kinematic model of the avatar, i.e., by performing inverse kinematics. The recipient device can then display the avatar message by playing the audio stream in correspondence with the plurality of motions of the avatar frame-by-frame. Thus, the receiving user can see the sending user's avatar delivering the message, with the lips (and possibly other body parts) moving in synch with the audio stream.

In some implementations, the avatar of the sending user can be pre-defined by the sending user and transmitted to the recipient device (e.g., via a remote server). The avatar can be rendered as a two-dimensional (2D) or three-dimensional (3D) virtual object on the XR device. In some implementations, the avatar can be a graphical representation of the sending user. Although avatars can be created based on fictional characteristics, the sending user can create his avatar to reflect his real-world physical traits, such as his face shape, skin tone, eye color, hair color, body type, and the like. To provide a further customizable experience, the sending user can further personalize his avatar to reflect his unique style, such as by selection of clothing and accessories. Thus, the sending user can create his avatar to be a highly customized expression of himself, allowing for a more personal interaction via messaging via mere text messaging.

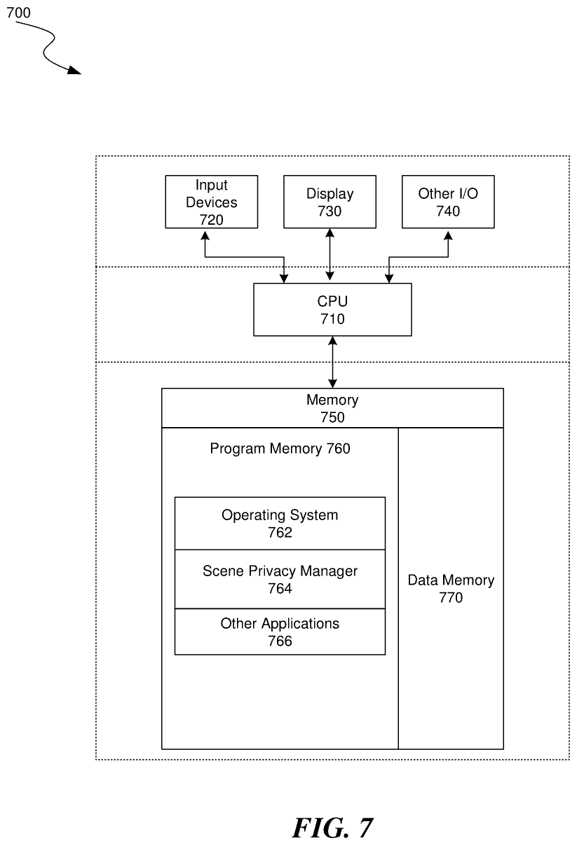

FIG. 7 is a block diagram illustrating an overview of devices on which some implementations of the disclosed technology can operate. The devices can comprise hardware components of a device 700 as shown and described herein. Device 700 can include one or more input devices 720 that provide input to the Processor(s) 710 (e.g., CPU(s), GPU(s), HPU(s), etc.), notifying it of actions. The actions can be mediated by a hardware controller that interprets the signals received from the input device and communicates the information to the processors 710 using a communication protocol. Input devices 720 include, for example, a mouse, a keyboard, a touchscreen, an infrared sensor, a touchpad, a wearable input device, a camera- or image-based input device, a microphone, or other user input devices.

Processors 710 can be a single processing unit or multiple processing units in a device or distributed across multiple devices. Processors 710 can be coupled to other hardware devices, for example, with the use of a bus, such as a PCI bus or SCSI bus. The processors 710 can communicate with a hardware controller for devices, such as for a display 730. Display 730 can be used to display text and graphics. In some implementations, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 740 can also be coupled to the processor, such as a network card, video card, audio card, USB, firewire or other external device, camera, printer, speakers, CD-ROM drive, DVD drive, disk drive, or Blu-Ray device.

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The processors 710 can have access to a memory 750 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 750 can include program memory 760 that stores programs and software, such as an operating system 762, ______ 764, and other application programs 766. Memory 750 can also include data memory 770, which can be provided to the program memory 760 or any element of the device 700.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

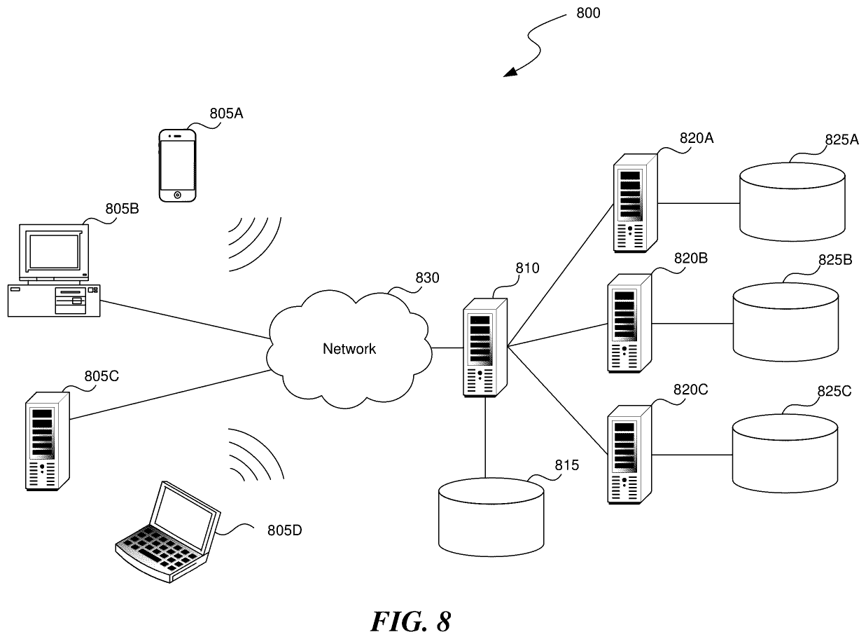

FIG. 8 is a block diagram illustrating an overview of an environment 800 in which some implementations of the disclosed technology can operate. Environment 800 can include one or more client computing devices 805A-D, examples of which can include device 700. Client computing devices 805 can operate in a networked environment using logical connections through network 830 to one or more remote computers, such as a server computing device.

In some implementations, server 810 can be an edge server which receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g., store) information. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

In some implementations, servers 810 and 820 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing a user scene with privacy preserving components, the method comprising:
generating a user scene comprising a user's mapped real-world environment, the user's mapped real-world environment comprising a plurality of real-world objects and the user scene comprising a plurality of scene components that correspond to the mapped real-world objects;
determining that one or more of the mapped real-world objects comprise private user objects;
replacing, in the user scene, scene components that correspond to the private user objects with generic components that obscure the private user objects, wherein each generic component comprises approximate dimensions that match each obscured private user object; and
exposing the user scene to one or more XR applications that interact with the user scene.

2. A method for providing an avatar message by an artificial reality device, the method comprising:
obtaining multimodal input from a user via the artificial reality device, the multimodal input including an audio stream, indicative of speaking by the user, corresponding in time to an image stream, indicative of movements by the user;
defining pose data of the user, corresponding in time to the audio stream, by mapping the image stream to a kinematic model of the user; and
transmitting the audio stream and the pose data,
wherein an other artificial reality device receives the audio stream and the pose data, defines a plurality of motions for an avatar of the user by mapping the pose data to a kinematic model of the avatar, and displays the avatar message by playing the audio stream in correspondence with the plurality of motions of the avatar of the user.

3. A system as shown and described herein.
